(19) United States
(12) Patent Application Publication
(10) Pub. No.: US 2001/0053048 A1
(43) Pub. Date: Dec. 20, 2001

(54) Actuator with reinforced voice coil

(76) Inventors: Jierapipatanakul Niroot, Singapore (SG); Andre Liem, Singapore (SG); Chee Wai Seetoh, Singapore (SG); Joseph Heng Tung Lau, Singapore (SG); Xiong Liu, Singapore (SG)

Correspondence Address: Derek J. Berger, Seagate Technology LLC, Intellectual Property - COL2LGL, 389 Disc Drive, Longmont, CO, 80503, US

(21) Appl. No.: 09/883,699

(22) Filed: Jun. 18, 2001

Related U.S. Application Data
(60) Provisional application No. 60/212,708, filed on Jun. 20, 2000.

(51) Int. Cl. G11B 5/55

(52) U.S. Cl. 360/264.7

(57) ABSTRACT

An actuator includes a coil support that is integral with the hub. The support includes a flange disposed between two support arms. Joining the flange to the hub is a base that defines a groove in which resides a proximal leg of a voice coil. The voice coil is attached to the flange and the support arms, as well as to the base.

### CROSS REFERENCE TO RELATED APPLICATIONS

This application claims the benefit of U.S. Provisional Application No. 60/212,708, filed Jun. 20, 2000.

### FIELD OF THE INVENTION

The present invention relates generally to disc drives. More particularly, the present invention relates to an actuator-voice coil with improved translational mode characteristics.

### BACKGROUND OF THE INVENTION

Disc drives in which data is stored on rotatable discs are well known. A read/write head is suspended over the disc surface as the latter is rotated so that data is recorded in generally circular tracks on the disc surface. As track density increases, the ability of the servo system to keep the read/write heads on-track becomes critical. The mechanical component of the servo, namely the actuator, has generally been the limiting factor in the overall improvement of the servo system. In particular, resonance of the actuator introduces a frequency-dependent delay for which the servo controller is unable to adequately compensate. An actuator with high rigid body mode, also referred to as the translational mode, is generally preferred as this, in combination with high servo bandwidth, provides a servo system with favorable sensitivity characteristics.

It has been recognized that the actuator is dominated by the low frequency of the coil. The coil itself has negligible stiffness owing to the soft plastics that are used to insulate and bond the wires. The prongs by which the coil is attached to the actuator hub cannot adequately compensate for the low frequency of the coil without being so massive that the actuator could not be balanced or have a useful seek time.

It has been proposed in the past that stiffness of the coil can be improved by filling the hole in the coil with material. However, this measure fails to make much improvement because the coil remains unable to resist shear well enough.

One other solution that has been proposed involves the introduction of two very thin plates of stainless steel or carbon-fiber composite, above and/or below the coil. The plates unfortunately passes through the magnet gap and reduces the torque constant of the voice coil motor, and thereby affecting the performance of the disc drive.

What the prior art has been lacking is an effective structure for raising the resonance frequency of the actuator in spite of the low frequency of the coil without interfering with the magnetic field between the magnet and coil.

### SUMMARY OF THE INVENTION

Disclosed is an actuator for use with a coil of a voice coil motor. The actuator is pivotally mounted to a housing component of a disc drive. The actuator includes a support connected to and extending away from hub. The support includes two support arms with proximal ends joined to the hub. A flange, which forms part of the support, is disposed between the support arms. Joining the flange to the hub is a base that is also part of the support. The base defines a slot in which the coil resides. The voice coil motor further includes a magnet that is mounted to the housing component. The coil is attached to the flange and to the support arms such that it is disposed above the magnet.

These and various other features as well as advantages which characterize the present invention will be apparent upon reading of the following detailed description and review of the associated drawings.

### BRIEF DESCRIPTION OF THE DRAWINGS

FIG. 1 is a perspective view of a disc drive incorporating the present invention.

FIG. 2 is a perspective view of an actuator according to a preferred embodiment of the present invention.

FIG. 3 is a bottom view of the actuator of FIG. 2.

FIG. 4 is a schematic side view of the actuator in assembly with a voice coil motor.

FIG. 5 is a bottom view of an actuator according to an alternative embodiment.

FIG. 6 is a top view of the actuator of FIG. 5.

### DETAILED DESCRIPTION

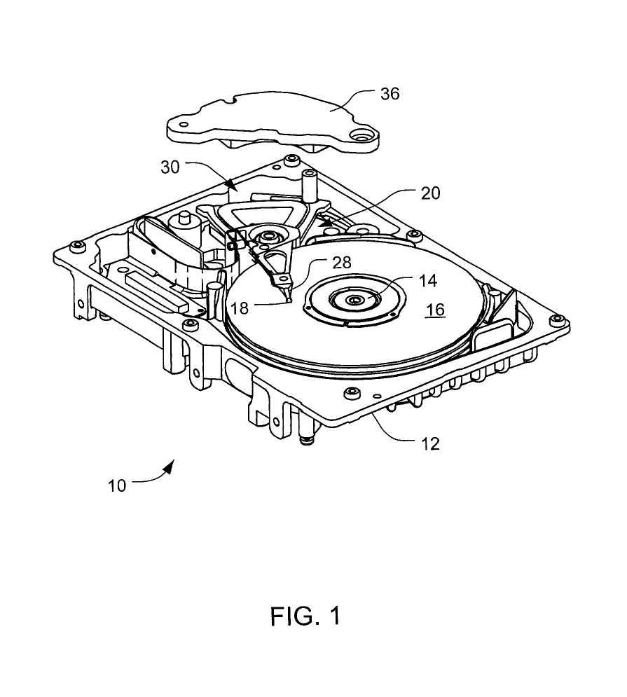

Referring now to FIG. 1, a disc drive 10 incorporating a preferred embodiment of the present invention is shown. Mounted on the housing component 12 is a spindle motor 14 supporting one or more discs 16 on which data can be recorded in circular tracks. Read/write heads 18 corresponding to each recordable surface of the discs are positioned to the desired track during drive operations to read data from or to write data to the discs. The position of each read/write head is controlled by a servo system of which an actuator 20 forms a part.

The actuator 20 is formed with a hub 22 that is pivotally mounted to the housing component 12. The pivotal mounting can be effected through the use of a ball bearing pivot cartridge 24. The hub 22 is secured to the sleeve of the pivot cartridge which is rotatable about a shaft. The shaft is fixed to the housing component 12 such that the actuator 20 can rotate relative to the housing component 12.

Extending laterally from the hub 22 is one or more actuator arms 26. Each actuator arm 26 holds out one or more suspensions 28 which in turn support read/write heads 18 at the tips. As the actuator 20 rotates, the read/write heads 18 follow an arcuate path over the disc surface, thus enabling the read/write heads to access different tracks for the reading or recording of data. During the read/write operations, the discs 16 are rotated by the spindle motor 14 such that the read/write heads 18 when held on-track can read from or write to the same track. The servo system is thus required to enable the read/write heads to keep on the same track or to seek out a new track.

The actuator 20 is coupled to a voice coil motor 30 for controlled rotational movement. The voice coil motor 30 has at least one magnet 32 and a coil of wires 34. When the coil 34 is activated by a passing current, electromotive forces generated produces a torque on the actuator 20, thereby causing the actuator to rotate. The voice coil motor 30 shown in this example has its magnet 32 fixedly mounted to the housing component 12 and the coil 34 coupled to the actuator 20. As part of the voice coil motor, a yoke 36 is provided for directing or closing the magnetic flux paths. Ideally, the magnetic flux paths should be substantially parallel to one another, and perpendicular to the active legs 38 of the coil. The coil is located in the air gap 40 immediately above the magnet, allowing for clearance with the upper surface 42 of the magnet, so as to maintain a small air gap.

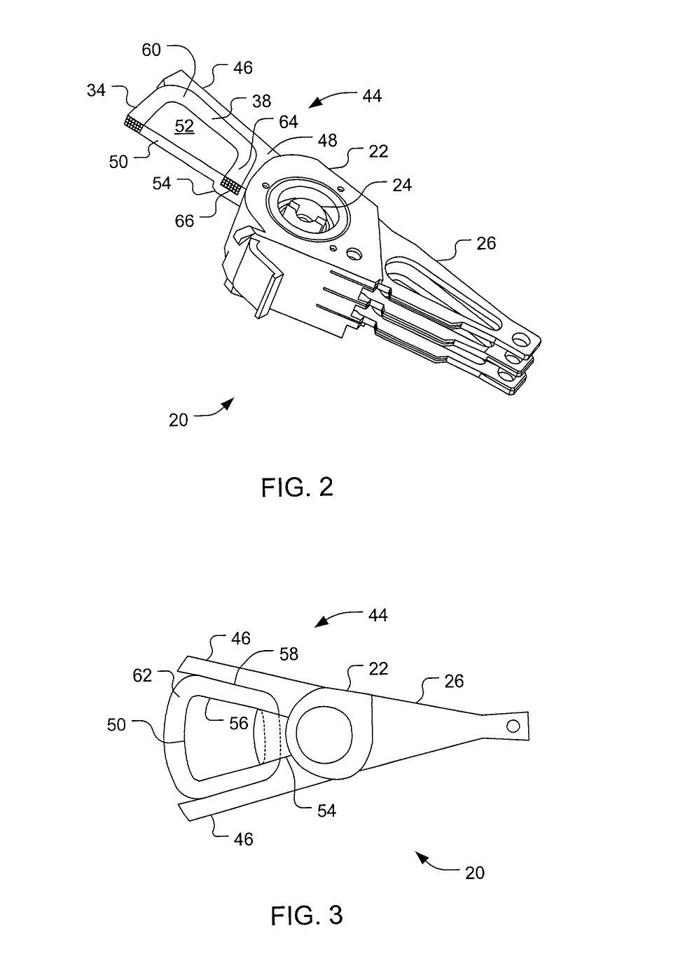

FIG. 2 shows an actuator 20 according to a preferred embodiment of the present invention, with part of its support 44 for a coil 34 partially cut away to better illustrate features of the support. The support 44 includes two support arms 46 which have their proximal ends 48 joined to the hub 22 such that the support arms 46 extend generally in a lateral direction diametrically opposed to the actuator arms 26. A flange 50 is located between the support arms 46, with its major surfaces 52 substantially parallel to a lateral plane so as to define a slot 66 in which the coil resides. A base 54, disposed between the proximal ends 48 of the support arms, joins the flange 50 to the hub 22. The base 54, the hub 22 and the flange 50 are preferably of unitary construction, meaning they are formed as a monolithic unit of the same material. The hub 22 and the support 44 are also of unitary construction. Aluminum is one example of a material that can be used in fabricating the actuator 20, although other metals, composites and ceramics may also be chosen.

Epoxy adhesive can be used to fix the coil 34 within the slot 66 of the support 44 such that the inner sides 56 of the coil are attached to the flange 50, and the outer sides 58 of the coil are attached to the support arms 46. The upper side 60 of the coil is uncovered to facilitate assembly of the coil 34 to the support 44. Referring to FIG. 3 for a bottom view of the actuator 20, it can be seen that the lower side 62 of the coil, and particularly of the active legs 38 of the coil, is mostly uncovered.

Besides supporting the flange 50, the base 54 also provides support to a proximal leg 64 of the coil. Referring back to FIG. 2, it can be seen that the base 54 provides a proximal groove portion of the slot 66 for engaging the proximal leg 64 of the coil.

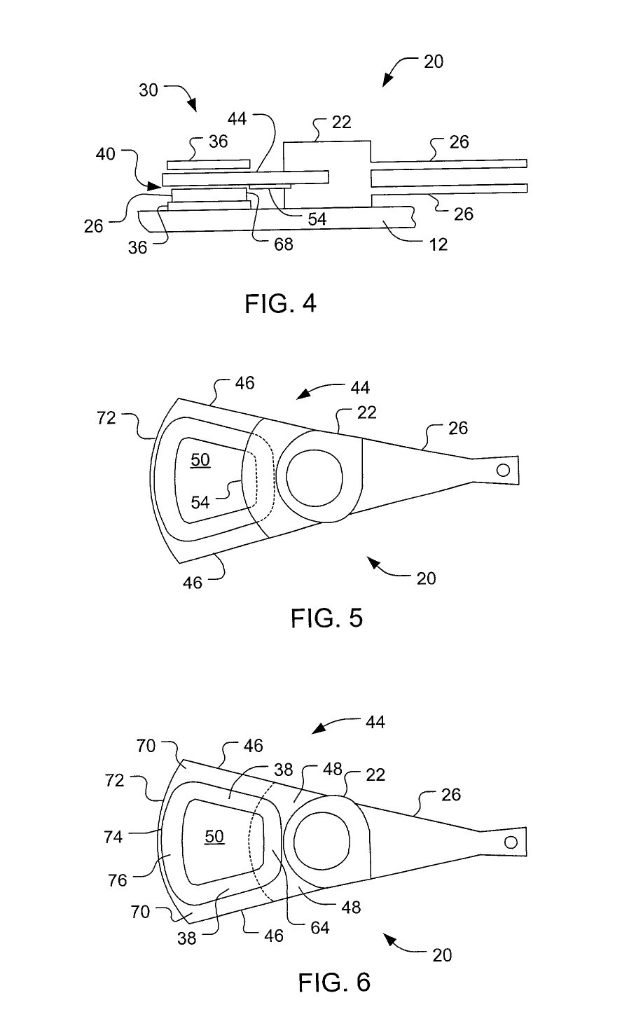

FIG. 4 shows the actuator 20 when in assembly in a disc drive 10. The base 54 is shown to begin from the hub 22 at an elevation lower than the support arms 46. The base 54 is adjacent to a near side 68 of the magnet that is nearest to the hub 22, and the base 54 is configured so that a clearance is maintained between the base 54 and the near side 68 of the magnet.

The flange 50 is positioned so that it is essentially the same distance away from the upper surface 42 of the magnet as the support arms 46 are. The flange 50 is shaped such that it does not come between the lower side 62 of coil and the magnet 32, so as to avoid increasing the air gap 40 which could adversely affect the performance of the actuator 20.

A bottom view of an alternative embodiment is shown in FIG. 5 and a top view of the same is shown in FIG. 6. In this example, the base 54 continues from the support arms 46 to define a longer groove 66 for supporting the coil 34. The shape of the base 54 may vary while maintaining its function of supporting the flange. The base 54 may cover part of the two active legs 38 of the coil. The base 54, however, is configured such that it stops clear of the magnet 32 when in assembly with the other voice coil motor components. Most of the active legs 38 are not covered by the base 54 so as to avoid any need to increase the air gap 40. Part of the proximal leg 64 of the coil may be adhered directly to the hub 22. Distal ends 70 of the support arms may be further integrally joined by a connecting arm 72, with the outer side 74 of a distal leg 76 of the coil joined to the connecting arm 72.

Alternatively stated, a first contemplated embodiment of the invention takes the form of an actuator 20 for use in a disc drive 10, including a hub 22 and a coil support 44 extending from the hub 22. The coil support 44 includes two support arms joined to the hub 22 at proximal ends. The coil support 44 also includes a flange 50 between the support arms and a base 54 joining the flange 50 to the hub 22, such that a slot 66 is defined between the flange 50 and support arms 46 for supporting a coil 62. Preferably, the flange 50, the base 54 and the hub 22 are of unitary construction. Optionally, the support arms 46 and the hub 22 may be of unitary construction. As a further option, the support arms 46 and the base 54 may be of unitary construction. As yet another option, distal ends of the support arms 46 may be connected by a connecting arm 72. The coil 62 may optionally be supported entirely within the slot 66. Adhesive may be provided as a further option for holding the coil 62 in the slot 66, and the adhesive may take the form of an epoxy. Optionally, the flange 54 and the support arms 46 may have thicknesses which are substantially equal.

Alternatively stated, a second contemplated embodiment of the invention takes the form of a disc drive 10 including a housing 12, an actuator 20 pivotally mounted to the housing 12 and a voice coil motor 30. The actuator includes a hub 22 and a coil support 44 extending from the hub 22. The coil support 44 includes two support arms joined to the hub 22 at proximal ends. The coil support 44 also includes a flange 50 between the support arms and a base 54 joining the flange 50 to the hub 22, such that a slot 66 is defined between the flange 50 and support arms 46 for supporting a coil 62. The voice coil motor 30 includes a magnet 26 mounted to the housing 12 and a coil 62 disposed above the magnet 26 within the slot 66. Optionally, the magnet 26 lies in a horizontal plane, and no portion of the base 54 is located directly above the magnet 26.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts without departing from the scope and spirit of the present invention.

What is claimed is:

1. An actuator for use in a disc drive, comprising:
a hub;
a coil support extending from the hub, the coil support comprising:
two support arms, each having a proximal end joined to the hub;
a flange disposed between the support arms; and
a base joining the flange to the hub, such that a slot is defined between the flange and support arms for supporting a coil.

2. An actuator of claim 1, in which the flange, the base and the hub are of unitary construction.

3. The actuator of claim 1, in which the support arms and the hub are of unitary construction.

4. The actuator of claim 1, in which the support arms and the base are of unitary construction.

5. The actuator of claim 1, in which the support arms each comprise a distal end, the actuator further comprising:
a connecting arm connecting the distal ends of the support arms.

6. The actuator of claim 1, further comprising:
a coil, the coil being supported entirely within the slot.

7. The actuator of claim 6, further comprising:
adhesive for holding the coil in the slot.

8. The actuator of claim 7, in which the adhesive comprises an epoxy.

9. The actuator of claim 1, in which the flange and the support arms have thicknesses which are substantially equal

10. A disc drive comprising:
a housing;
an actuator pivotally mounted to the housing, the actuator comprising:
a hub; and
a coil support, the coil support further comprising:
two support arms, each having a proximal end joined to the hub;
a flange disposed between the support arms; and
a base joining the flange to the hub, such that a slot is defined between the flange and support arms for supporting a coil; and
a voice coil motor comprising:
a magnet mounted to the housing; and
a coil disposed above the magnet within the slot.

11. The disc drive of claim 10, in which the magnet lies in a horizontal plane, and in which no portion of the base is located directly above the magnet.

12. An actuator for use in a disc drive, comprising:
a hub;
a coil; and
means for coupling the voice coil to the hub.

13. The actuator of claim 12, in which the coupling means includes an adhesive for adhering the coil to the coupling means.

14. The actuator of claim 12, in which the coupling means and the actuator are of unitary construction.
